(19) United States
(12) Patent Application Publication
(10) Pub. No.: US 2017/0155866 A1
(43) Pub. Date: Jun. 1, 2017

(54) METHOD AND DEVICE FOR CONTROLLING TELEVISION

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Xueqiang SHI, Beijing (CN)

(21) Appl. No.: 15/247,785

(22) Filed: Aug. 25, 2016

Related U.S. Application Data
(63) Continuation of application No. PCT/CN2016/088893, filed on Jul. 6, 2016.

(30) Foreign Application Priority Data
Dec. 1, 2015 (CN) 201510870789.0

(51) Int. Cl. H04N 5/44

(52) U.S. Cl. CPC H04N 5/4403; H04N 2005/4405

(57) ABSTRACT

The present disclosure discloses a method and a device for controlling a television. The method comprises the following steps: receiving, by television equipment, a control instruction that is sent from mobile equipment after the television equipment and the mobile equipment establish a connection; transferring the control instruction to a command interpreter according to a system commissioning assembly; sending, by the command interpreter, a control command to an operating system; and controlling a currently running application by means of the control instruction that is received by the operating system, so as to bypass a signature of the system and thereby to realize the control on the television equipment by means of the mobile equipment.

### CROSS-REFERENCE TO RELATED APPLICATIONS

The present disclosure is a continuation of International Application No. PCT/CN2016/088893 filed on Jul. 6, 2016, which is based upon and claims priority to Chinese Patent Application No. 201510870789.0, entitled “method and device for controlling television”, filed Dec. 1, 2015, the entire contents of all of which are incorporated herein by reference.

### TECHNICAL FIELD

The present disclosure generally relates to the field of terminals, in particular to a method and a device for controlling a television.

### BACKGROUND

In the field of television equipment, the television equipment can be controlled by a series of operations from a remote controller; however, to employ the remote controller only to control the television equipment often brings users some inconveniences, such as the problem of insensitivity in operation caused by an ageing remote controller due to a long service time and the out-of-service problem of the remote controller due to a battery issue.

In the prior art, common mobile equipment cannot acquire a private signature in a television equipment system, and therefore cannot control the television equipment.

Therefore, an urgent problem to be solved by a person skilled in the art is to provide a method for controlling a television to control the television equipment through the mobile equipment.

### SUMMARY

The present disclosure discloses a method and a device for controlling a television through mobile equipment to solve the problem that the mobile equipment cannot control television equipment in the prior art.

An embodiment of the present disclosure discloses a method for controlling a television, comprising the following steps:

receiving, by television equipment, a control instruction that is sent from mobile equipment after the television equipment and the mobile equipment establish a connection;

transferring the control instruction to a command interpreter according to a system commissioning assembly;

sending, by the command interpreter, a control command to an operating system; and

controlling a currently running application by means of the control instruction that is received by the operating system.

Correspondingly, an embodiment of the present disclosure discloses an electronic device for controlling a television, comprising at least one processor; and a memory communicably connected with the at least one processor for storing instructions executable by the at least one processor, wherein execution of the instructions by the at least one processor causes the at least one processor to:

receive, by television equipment, a control instruction that is sent from mobile equipment after the television equipment and the mobile equipment establish a connection;

transfer the control instruction to a command interpreter according to a system commissioning assembly;

send, by the command interpreter, the control instruction to an operating system; and

control a currently running application by means of the control instruction that is received by the operating system.

An embodiment of the present disclosure discloses a computer program, comprising a computer readable code, which causes mobile equipment to execute the method for controlling the television above when operating on the mobile equipment.

An embodiment of the present disclosure discloses a non-transitory computer readable medium, storing executable instructions that, when executed by an electronic device, cause the electronic device to: receive, by television equipment, a control instruction that is sent from mobile equipment after the television equipment and the mobile equipment establish a connection; transfer the control instruction to a command interpreter according to a system commissioning assembly; send, by the command interpreter, the control instruction to an operating system; and control a currently running application by means of the control instruction that is received by the operating system.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a steps flowchart of a method for controlling a television according to some embodiments of the present disclosure.

FIG. 2 is a steps flowchart of a method for controlling a television according to some embodiments of the present disclosure.

FIG. 3 is a structural block diagram of a device for controlling a television according to some embodiments of the present disclosure.

FIG. 4 is a structural block diagram of a device for controlling a television according to some embodiments of the present disclosure.

FIG. 5 schematically illustrates a block diagram of mobile equipment used to execute the method according to some embodiments of the present disclosure;

FIG. 6 schematically illustrates a memory cell used to keep or carry a program code for realizing the method according to some embodiments of the present disclosure.

### DESCRIPTION OF THE EMBODIMENTS

In order to make objects, technical solutions and advantages of the embodiments of the present disclosure more apparent, the technical solutions in the embodiments of the present disclosure will be described in a clearly and fully understandable way in connection with the drawings related to the embodiments of the present disclosure. It is obvious that the described embodiments are just a part but not all of the embodiments of the present disclosure. Based on the described embodiments herein, a person skilled in the art can obtain other embodiment(s), without any inventive work, which should be within the scope of the present disclosure.

### Embodiment One

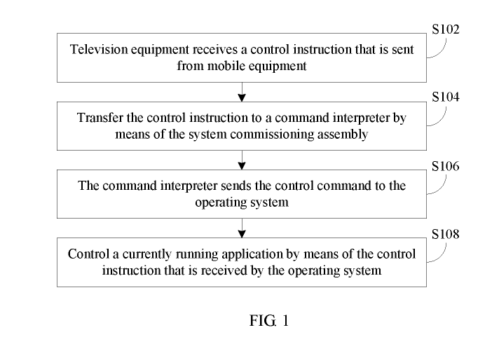

With reference to FIG. 1, which illustrates a steps flowchart of a method for controlling a television according to an embodiment of the present disclosure, the method may specifically include the steps as follows.

Step S102 that television equipment receives a control instruction that is sent from mobile equipment.

When a user employs the television to watch a television program, external equipment such as a remote controller is often required for the remote control on the television. With the progress of technology, the user can also employ the mobile equipment such as a smartphone, a tablet computer and the like for the remote control on an intelligent television. A signature in an intelligent television system is private, which means that only internal personnel can invoke a standard interface that is provided by the system according to the signature of the system to realize the control on the intelligent television.

As the signature of the system is private, so that an ordinary user cannot acquire the signature and therefore a third party intelligent television cannot be controlled directly by means of the external equipment.

In order to solve the above technical problem to realize that the user can control the intelligent television by bypassing the signature of the system, an embodiment of the present disclosure discloses an operating system to directly send a control command to the intelligent television by means of a system commissioning assembly and a command interpreter, and then the operating system sends a control instruction to a currently running application so as to realize the control on the television equipment through the mobile equipment.

The mobile equipment and the television equipment establish a connection through an HTTP (Hypertext Transfer Protocol). As the basis of Web networking and one of frequently used protocols for mobile phone networking, HTTP is an application that is established on the basis of TCP (Transfer Control Protocol). After the connection is established, the mobile equipment sends to the television equipment the control instruction, and the television equipment receives the control instruction that is sent from the mobile equipment, wherein the control instruction includes an instruction, which is sent from the mobile equipment, for an operating control on the intelligent television.

Step S104 of transferring the control instruction to the command interpreter by means of the system commissioning assembly.

After finishing receiving the control instruction, the television equipment transfers the control instruction to the command interpreter by means of the system commissioning assembly such as an ADB (Android Debug Bridge), wherein the system commissioning assembly can realize the transfer of the control instruction by means of the function of copying a file to equipment or copying the file from the equipment based on the ADB, so as to bypass the signature of the system and thereby realize the control on the television equipment through the mobile equipment.

The command interpreter is configured to interpret the control instruction to realize a formatted conversion for the control instruction. An instruction signal in the operating system is a machine instruction in general, namely an instruction that can be identified by a machine, such as a binary instruction, so that the command interpreter performs the formatted conversion for the control instruction that is received by the television equipment.

Step S106 that the command interpreter sends the control command to the operating system.

The command interpreter sends the converted control instruction to the operating system through an input program; namely, the machine instruction is inserted in the input program, and is sent to the operating system by executing the input program.

Step 108 of controlling the currently running application through the control instruction that is received by the operating system.

The operating system receives the control instruction, namely the machine instruction, looks for the currently running application according to the machine instruction, and controls the current application through the machine instruction.

For example, the control instruction is a channel changing operation, which is converted into the machine instruction; and the current application changes a current television channel to a television channel corresponding to the machine instruction according to the machine instruction. For another example, the control instruction is to turn up the volume for three units, which is converted into the machine instruction; and the current application turns up volume of the current television for three volume units on the original basis according to the machine instruction.

According to the embodiment of the present disclosure, through the connection that is established between the mobile equipment and the television equipment, the mobile equipment sends to the television equipment the control instruction firstly, then the system commissioning assembly in the television equipment passes the control instruction back to the command interpreter, and the command interpreter sends to the operating system the control command. The currently running application is controlled through the control instruction, and therefore the control on the television equipment through the mobile equipment is realized by bypassing the signature of the system.

The embodiment of the present disclosure may be applied to a television control system, wherein the television control system includes a server, the mobile equipment and the television equipment. The television equipment is controlled through the mobile equipment, wherein the mobile equipment is such as a mobile phone, a tablet computer and the like, and the television equipment is such as an intelligent television, a set top box and the like. A multi-terminal interaction application may be installed in each of the mobile equipment and the television equipment, and the interaction between the mobile equipment and the television equipment can be realized based on the multi-terminal interaction application. The respective multi-terminal interaction application of both the mobile equipment and the television equipment may be interacted with the server to acquire corresponding content.

Wherein, the multi-terminal interaction application at the mobile terminal may be interacted with the server to acquire various information of the television, and may be interacted with the multi-terminal interaction application at the television equipment to realize the control on the television equipment. Namely, the multi-terminal interaction applications are configured to realize data interaction between different terminals, such as a “multi-screen have a look” application, a remote controller application and the like.

### Embodiment Two

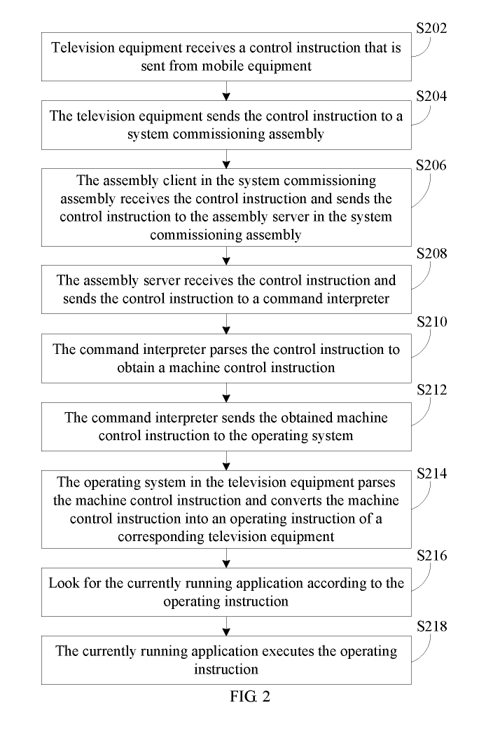

With reference to FIG. 2, which illustrates a steps flowchart of a method for controlling a television according to another embodiment of the present disclosure, the method may specifically include the steps as follows.

Step S202 that television equipment receives a control instruction that is sent from mobile equipment.

A first multi-terminal interaction application (such as a remote controller application) is installed in the mobile equipment, and a second multi-terminal interaction application (such as a “multi-screen have a look” application) is installed in the television equipment, wherein the television equipment includes an intelligent television and a television set top box, and the second multi-terminal interaction application may be installed in the television set top box; the first multi-terminal interaction application in the mobile equipment sends a connection request to the second multi-terminal interaction application in the television equipment, and the second multi-terminal interaction application in the television equipment receives the connection request, and establishes an HTTP connection with the mobile equipment so as to lay a foundation for the interaction between the mobile equipment and the television equipment.

After the television equipment and the mobile equipment establish the connection, the second multi-terminal interaction application in the television equipment receives the control instruction that is sent from the first multi-terminal interaction application in the mobile equipment, wherein the control instruction includes an instruction, which is sent from the mobile equipment, for an operating control on an intelligent television.

According to an embodiment of the present disclosure, some shortcut keys (such as control keys on a television remote controller) may be preset in the first multi-terminal interaction application in the mobile equipment; after the mobile equipment and the television equipment establish the connection, the television equipment is controlled by activating these shortcut keys, such as to change a channel, to turn up volume, to turn down the volume and the like.

Step S204 that the television equipment sends the control instruction to a system commissioning assembly.

The second multi-terminal interaction application in the television equipment sends the received control instruction to the system commissioning assembly, wherein the system commissioning assembly includes an assembly client and an assembly server.

The system commissioning assembly is configured to transfer the control instruction that is sent from the second multi-terminal interaction application in the television equipment to bypass a signature of a system, and thereby to realize the control on the intelligent television.

Wherein, the television equipment includes the intelligent television and the television set top box; the second multi-terminal interaction application may be installed in the television set top box or an operating system of the intelligent television, and may include the “multi-screen have a look” application; the “multi-screen have a look” application is an HTTP server, and is configured to connect the first multi-terminal interaction application in the mobile equipment; and the first multi-terminal interaction application may include an application, which is installed at the mobile terminal, for sending the control instruction.

The system commissioning assembly may include an ADB client application and a server program in an Android system.

Step S206 that the assembly client in the system commissioning assembly receives the control instruction and sends the control instruction to the assembly server in the system commissioning assembly.

Step S208 that the assembly server receives the control instruction and sends the control instruction to a command interpreter.

The assembly client and the assembly server are established in the system commissioning assembly. After the assembly server receives the control instruction, the assembly client and the assembly server establish a connection relationship to transfer the control instruction.

The assembly client receives the control instruction that is sent from the second multi-terminal interaction application in the television equipment, wherein the assembly client sends the received control instruction to the assembly server, and the assembly server sends the control instruction to the command interpreter.

For example, the “multi-screen have a look” application is installed in the television set top box in the television equipment to establish the connection relationship with the mobile equipment, namely a mobile phone, and to receive the control instruction; the ADB client application is invoked in the Android system; the “multi-screen have a look” application at the television terminal receives the control instruction that is sent from an application of the mobile phone, and instructs to transmit to the ADB client application at the television terminal; after the ADB client application at the television terminal and an ADB server program at a television terminal establish a connection, the control instruction that is received from a mobile phone terminal is sent to the ADB server program at the television terminal; and then the ADB server program at the television terminal sends the control instruction to the command interpreter.

Step S210 that the command interpreter parses the control instruction to obtain a machine control instruction.

Step S212 that the command interpreter sends the obtained machine control instruction to the operating system.

When receiving the control instruction, the command interpreter converts the control instruction to a machine instruction, namely an instruction that can be identified by a machine, for example a binary instruction; an input program is invoked according to the machine instruction; and the machine instruction is inserted into the input program; and the machine instruction is sent to the operating system by executing the input program.

For example, a shell program of the command interpreter activates a formatted conversion for the control instruction, and the control instruction is converted into the machine instruction; the input program is invoked to insert the machine instruction into the input program; and the input program sends the inserted machine instruction to the operating system by executing the input program, wherein a command of the command interpreter can simulate a simple key event, for example the machine instruction is inserted in the input program in the format of input text “character string”, and for another example the simulated key event is in the format of input key event Num.

Step S214 that the operating system in the television equipment parses the machine control instruction and converts the machine control instruction into an operating instruction of the television equipment.

The operating system in the television equipment receives the machine instruction that is sent from the input program, parses the machine instruction, and converts the machine instruction into the operating instruction of a corresponding intelligent television, wherein the operating instruction is used to control a currently running application in the intelligent television.

Step S216 of looking for the currently running application according to the operating instruction.

Step S218 that the currently running application executes the operating instruction.

All applications in the intelligent television are looked for according to the operating instruction to find out the currently running application in the system; the operating instruction is sent to the currently running application; and the currently running application executes the operating instruction.

For example, the control instruction is a channel changing operation, which is converted into the machine instruction; and the current application converts the machine instruction into the operating instruction according to the machine instruction to change a current television channel to a television channel corresponding to the operating instruction. If the control instruction is to turn up the volume for three units, which is converted into the machine instruction; the machine instruction is converted into the operating instruction; and the current application turns up volume of the current television for three volume units on the original basis according to the operating instruction.

According to the embodiment of the present disclosure, through the HTTP connection that is established between the first multi-terminal interaction application in the mobile equipment and the second multi-terminal interaction application in the television equipment, the first multi-terminal interaction application in the mobile equipment sends the control instruction to the second multi-terminal interaction application in the television equipment firstly, then the second multi-terminal interaction application sends the control instruction to the assembly client in the system commissioning assembly, the assembly client sends the control instruction to the assembly server, the assembly server passes the control instruction back to the command interpreter, the command interpreter performs the formatted conversion on the control instruction to obtain the machine instruction, the machine instruction is sent to the operating system, the operating system converts the machine instruction into the operating instruction, looks for the currently running application according to the operating instruction, and executes the operating instruction according to the currently running application so as to bypass the signature of the system and thereby to realize the control on the television equipment through the mobile equipment.

It should be noted that: for the purpose of brief description, method embodiments are described as the combination of a series of actions, but a person skilled in the art should know that the embodiments of the present disclosure are not limited to the order of the described actions, because some steps may be executed in other orders or at the same time according to the embodiments of the present disclosure. Furthermore, a person skilled in the art should also know that all the embodiments described in the specifications belong to embodiments, and therefore related actions are not always necessary for the embodiments of the present disclosure.

### Embodiment Three

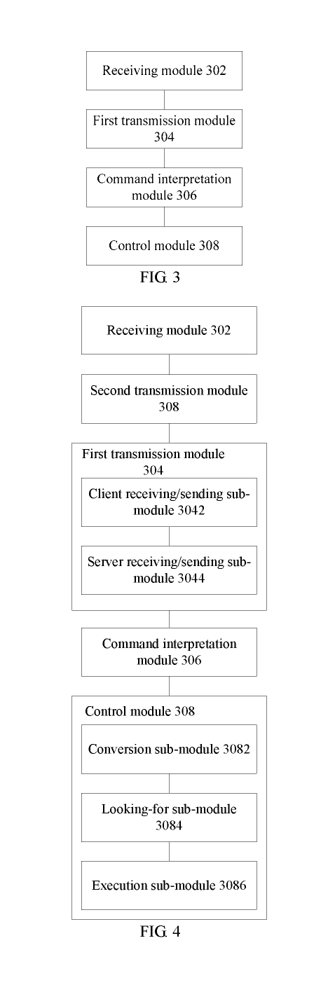

With reference to FIG. 3, which illustrates a structural block diagram of a device for controlling a television according to an embodiment of the present disclosure, the device may specifically include the following modules:

a receiving module 302, which is configured for that television equipment receives a control instruction that is sent from mobile equipment after the television equipment and the mobile equipment establish a connection; a first transmission module 304, which is configured to transfer the control instruction to a command interpreter according to a system commissioning assembly; a command interpretation module 306, which is configured for that the command interpreter sends the control instruction to an operating system; and a control module 308, which is configured to control a currently running application by means of the control instruction that is received by the operating system.

Wherein, the receiving module 302 may be installed with a multi-terminal interaction application, such as a “multi-screen have a look” application, which is used to establish the connection with the mobile equipment, receive the control instruction and forward the control instruction; and the “multi-screen have a look” application may be installed in the operating system of intelligent television.

According to a preferable embodiment of the present disclosure, the above modules forms the device that is installed in a television set top box; and the set top box is controlled by means of the mobile equipment so as to realize an interaction with a third party television.

The device embodiment of the present disclosure is implemented according to the above method embodiments. Through the connection that is established between the mobile equipment and the television equipment, the mobile equipment sends the control instruction to the receiving module; the first transmission module is configured for that the system commissioning assembly passes the control instruction back to the command interpreter; a command interpretation module sends a control command to the operating system; and the control on the currently running application is realized through the control instruction so as to bypass a signature of the system and thereby to realize the control on the television equipment through the mobile equipment.

Device embodiments are briefly described herein as they are substantially similar to method embodiments; please refer to the description of the method embodiments for associated parts.

### Embodiment Four

With reference to FIG. 4, which illustrates a structural block diagram of a device for controlling a television according to another embodiment of the present disclosure, the device may specifically include:

a receiving module 302, a second transmission module 308, a first transmission module 304, a command interpretation module 306 and a control module 308, wherein the first transmission module 304 includes a client receiving-sending sub-module 3042 and a server receiving-sending sub-module 3044, and the control module 308 includes a conversion sub-module 3082, a looking-for sub-module 3084 and an execution sub-module 3086.

The receiving module 302 is configured for that television equipment receives a control instruction that is sent from mobile equipment; the second transmission module 308 is configured for that the television equipment sends the control instruction to a system commissioning assembly, wherein the system commissioning assembly includes an assembly client and an assembly server; the client receiving-sending sub-module 3042 is configured for that the assembly client in the system commissioning assembly receives the control instruction and sends the control instruction to the assembly server in the system commissioning assembly; the server receiving-sending sub-module 3044 is configured for that the assembly server receives the control instruction and sends the control instruction to a command interpreter; the command interpretation module 306 is configured for that the command interpreter sends a control command to an operating system; the conversion sub-module 3082 is configured for that the operating system in the television equipment parses a machine control instruction and converts the machine control instruction into an operating instruction of a corresponding television equipment; the looking-for sub-module 3084 is configured to look for a currently running application and send the operating instruction to the currently running application; and the execution sub-module 3086 is configured to execute the operating instruction on the currently running application so as to control the television equipment.

Wherein, a multi-terminal interaction application such as a remote controller control application is installed in the mobile equipment such as a mobile phone, a tablet computer and the like; another multi-terminal interaction application such as a “multi-screen have a look” application is also installed in the receiving module; through a connection relationship that is established between the multi-terminal interaction application in the mobile equipment and the multi-terminal interaction application in the device for controlling the television, the control instruction is sent to the television through the mobile equipment so as to realize the device for controlling the television and thereby to realize an interaction between a mobile terminal and the television.

The device embodiment of the present disclosure is implemented according to the above method embodiments. A signature of the system can be bypassed effectively, so that a user may directly control a third party television through the mobile equipment.

Device embodiments described above are illustrative only, wherein the unit described as a separate part may be or may be not physically separated, a part displayed as the unit may be or may be not a physical unit, may be located in one place, or may be distributed on a plurality of network units. Some or all of the modules may be selected to achieve the objective of the solutions of the embodiments according to actual requirements. A person skilled in the art may understand and implement it without investing creativity.

All embodiments in the specifications are described in a progressive manner. Each embodiment focuses on describing the differences from other embodiments, and please refer to each other for identical or similar parts of the respective embodiments.

A person skilled in the art should understand that embodiments of the present disclosure may provide a method, a device or a computer program product. Therefore, a hardware-only embodiment, a software-only embodiment or a hardware-software combined embodiment may be employed in the present disclosure. Moreover, the embodiments of the present disclosure may employ a computer program product that is executed on one or more computer-available storage mediums (including but not limited to a magnetic disk memory, a CD-ROM (Compact Disc Read-Only Memory), an optical memory and the like) in which a computer-available program code is included.

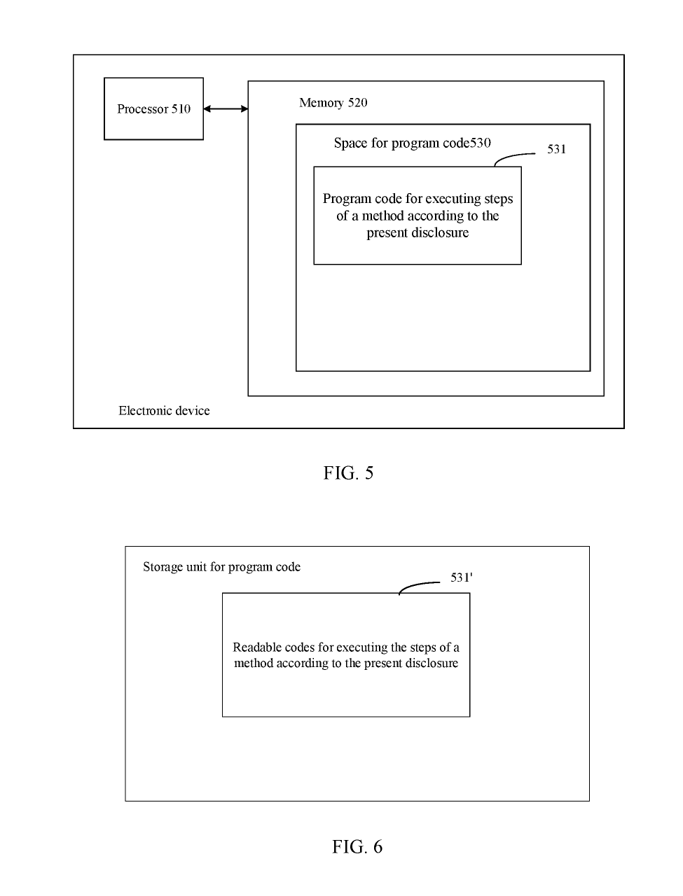

For example, FIG. 5 illustrates a block diagram of an electronic device for executing the method according the disclosure. Traditionally, the electronic device includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the server as shown in FIG. 5. The program codes may be compressed for example in an appropriate form. Usually, the memory cell includes computer readable codes 531′ which can be read for example by processors 510. When these codes are operated on the server, the server may execute respective steps in the method as described above.

The embodiments of the present disclosure are described with reference to flowcharts and/or block diagrams of a method, terminal equipment (system) and a computer program product according to the embodiment of the present disclosure. It should be understood that each flow and/or block in the flowcharts and/or the block diagrams and the combination of flows and/or blocks in the flowcharts and/or the block diagrams may be realized by computer program instructions. These computer program instructions may be provided to a general-purpose computer, a special-purpose computer, an embedded processor or other processors of programmable data processing terminal equipment to generate a machine, so that the instructions that are executed by the computers or other processors of the programmable data processing terminal equipment generate a device for realizing functions that are designated in one or more flows of the flowcharts and/or one or more blocks of the block diagrams.

These computer program instructions may also be stored a computer readable storage that can guide a computer or other programmable data processing terminal equipment to work in a specific manner, so that the instructions that are stored in the computer readable storage generate a produce that includes an instructing device, and the instructing device can realize the functions that are designated in one or more flows of the flowcharts and/or one or more blocks of the block diagrams.

These computer program instructions may also be loaded to a computer or other programmable data processing terminal equipment, so as to execute a series of operation steps on the computer or the other programmable data processing terminal equipment to generate computer-realized processing, and therefore the instructions that are executed on the computer or the other programmable data processing terminal equipment provide steps for realizing the functions that are designated in one or more flows of the flowcharts and/or one or more blocks of the block diagrams.

Although the preferable embodiments of the present disclosure have been described, a person skilled in the art may change or amend these embodiments in case of learning about the basic concept of creativity. Therefore, the accompanying claims are explained on purpose to include all changes and amendments within the scope of the present disclosure.

Finally, it should be noted that: the relational terms in the present disclosure, such as first, second and the like, are only employed to distinguish one entity or an operation from another entity or operation, and do not always claim or imply that there is any such actual relation or order between these entities or operations. Moreover, the term “comprise”, “include” or any other variants thereof intends to cover non-exclusive inclusions, so that a process, a method, an article or terminal equipment including a series of elements not only includes the indicated elements but also includes other elements that are not listed explicitly or inherent elements for the process, method, article or terminal equipment. In case of no further limitation, an element that is defined by the term “including a” does not exclude that additional identical elements also exist in the process, method, article or terminal equipment including the element.

According to the present disclosure, the method and device for controlling the television are described in detail. Principles and embodiments of the present disclosure are explained herein based on specific cases. The above embodiments are descriptions on technical solutions of the present disclosure only, and are not limitations to the technical solutions; although the present disclosure is described in detail with reference to the above embodiments, a person skilled in the art should understand that: they may also make amendments on the technical solutions that are recorded in the respective embodiments or make equal substitutions on part of technical characteristics in the technical solutions, and these amendments or substitutions do not enable corresponding technical solutions to essentially separate from the spirit and scope of the technical solutions according to the embodiments of the present disclosure.

What is claimed is:

1. A method for controlling a television, comprising:
receiving, by television equipment, a control instruction that is sent from mobile equipment after the television equipment and the mobile equipment establish a connection;
transferring the control instruction to a command interpreter according to a system commissioning assembly;
sending, by the command interpreter, a control command to an operating system; and
controlling a currently running application by means of the control instruction that is received by the operating system.

2. The method according to claim 1, wherein after the television equipment receives the control instruction that is sent from the mobile equipment, the method further comprising:
sending, by the television equipment, the control instruction to a system commissioning assembly, wherein the control instruction is employed to control the television equipment, and the system commissioning assembly comprises an assembly client and an assembly server.

3. The method according to claim 2, wherein transferring the control instruction to the command interpreter according to the system commissioning assembly comprises:
receiving, by the assembly client in the system commissioning assembly, the control instruction and sends the control instruction to the assembly server in the system commissioning assembly; and
receiving, by the assembly server, the control instruction and sending the control instruction to the command interpreter.

4. The method according to claim 3, wherein sending, by the command interpreter, the control command to the operating system comprises:
parsing, by the command interpreter, the control instruction to obtain a machine control instruction; and
sending, by the command interpreter, the obtained machine control instruction to the operating system.

5. The method according to claim 4, wherein controlling the currently running application by means of the control instruction that is received by the operating system comprises:
parsing, by the operating system in the television equipment, the machine control instruction and converting the machine control instruction into an operating instruction of the television equipment;
looking for the currently running application and sending the operating instruction to the currently running application; and
executing, by the currently running application, the operating instruction to control the television equipment.

6. The method according to claim 1, wherein the television equipment comprises an intelligent television and a television set top box.

7. An electronic device for controlling a television, comprising:
at least one processor; and
a memory communicably connected with the at least one processor for storing instructions executable by the at least one processor, wherein execution of the instructions by the at least one processor causes the at least one processor to:
receive, by television equipment, a control instruction that is sent from mobile equipment after the television equipment and the mobile equipment establish a connection;
transfer the control instruction to a command interpreter according to a system commissioning assembly;
send, by the command interpreter, the control instruction to an operating system; and
control a currently running application by means of the control instruction that is received by the operating system.

8. The electronic device according to claim 7, wherein execution of the instructions by the at least one processor causes the at least one processor to further:
send the control instruction to the system commissioning assembly, wherein the control instruction is employed to control the television equipment, and the system commissioning assembly comprises an assembly client and an assembly server.

9. The electronic device according to claim 8, wherein transfer the control instruction to a command interpreter according to a system commissioning assembly comprises:
receive, by the assembly client in the system commissioning assembly, the control instruction and sends the control instruction to the assembly server in the system commissioning assembly; and
receive, the assembly server, the control instruction and send the control instruction to a command interpreter;

10. The electronic device according to claim 9, wherein:
send, by the command interpreter, the control instruction to an operating system comprises: parse the control instruction to obtain a machine control instruction; and send, by the command interpreter, the obtained machine control instruction to the operating system.

11. The electronic device according to claim 10, wherein control a currently running application by means of the control instruction that is received by the operating system comprises:
parse, by the operating system in the television equipment, the machine control instruction and convert the machine control instruction into an operating instruction of a corresponding television equipment;
look for the currently running application and send the operating instruction to the currently running application; and
execute the operating instruction on the currently running application to control the television equipment.

12. The electronic device according to claim 7, wherein the television equipment comprises an intelligent television and a television set top box.

13. A non-transitory computer readable medium, storing executable instructions that, when executed by an electronic device, cause the electronic device to:
receive, by television equipment, a control instruction that is sent from mobile equipment after the television equipment and the mobile equipment establish a connection;
transfer the control instruction to a command interpreter according to a system commissioning assembly;
send, by the command interpreter, the control instruction to an operating system; and
control a currently running application by means of the control instruction that is received by the operating system.

14. The non-transitory computer readable medium according to claim 13, wherein the electronic device is further caused to:
send the control instruction to the system commissioning assembly, wherein the control instruction is employed to control the television equipment, and the system commissioning assembly comprises an assembly client and an assembly server.

15. The non-transitory computer readable medium according to claim 14, wherein transfer the control instruction to a command interpreter according to a system commissioning assembly comprises:
receive, by the assembly client in the system commissioning assembly, the control instruction and sends the control instruction to the assembly server in the system commissioning assembly; and
receive, the assembly server, the control instruction and send the control instruction to a command interpreter;

16. The non-transitory computer readable medium according to claim 15, wherein:
send, by the command interpreter, the control instruction to an operating system comprises: parse the control instruction to obtain a machine control instruction; and send, by the command interpreter, the obtained machine control instruction to the operating system.

17. The non-transitory computer readable medium according to claim 16, wherein control a currently running application by means of the control instruction that is received by the operating system comprises:
parse, by the operating system in the television equipment, the machine control instruction and convert the machine control instruction into an operating instruction of a corresponding television equipment;
look for the currently running application and send the operating instruction to the currently running application; and
execute the operating instruction on the currently running application to control the television equipment.

18. The non-transitory computer readable medium according to claim 13, wherein the television equipment comprises an intelligent television and a television set top box.
